(19) United States
(12) Patent Application Publication
(10) Pub. No.: US 2022/0178336 A1
(43) Pub. Date: Jun. 9, 2022

(54) ENERGY STORAGE AND BUFFERING USING MULTIPLE PRESSURE CONTAINERS

(71) Applicant: Energy Internet Corporation, Saratoga, CA (US)

(72) Inventors: Shankar Ramamurthy, Saratoga, CA (US); Liam Newcombe, Croydon (GB)

(21) Appl. No.: 17/676,897

(22) Filed: Feb. 22, 2022

Related U.S. Application Data
(63) Continuation-in-part of application No. 16/747,843, filed on Jan. 21, 2020.
Application No. 16/747,843 is a continuation-in-part of application No. 16/378,243, filed on Apr. 8, 2019, now Pat. No. 10,947,899.
Application No. 16/378,243 is a continuation-in-part of application No. 16/118,886, filed on Aug. 31, 2018, now Pat. No. 10,725,441.
(60) Provisional application No. 63/246,813, filed on Sep. 22, 2021.
(60) Provisional application No. 63/227,499, filed on Jul. 30, 2021.
(60) Provisional application No. 63/178,560, filed on Apr. 23, 2021.
(60) Provisional application No. 63/152,357, filed on Feb. 23, 2021.
(60) Provisional application No. 62/916,449, filed on Oct. 17, 2019.
(60) Provisional application No. 62/838,992, filed on Apr. 26, 2019.
(60) Provisional application No. 62/795,133, filed on Jan. 22, 2019.
(60) Provisional application No. 62/795,140, filed on Jan. 22, 2019.
(60) Provisional application No. 62/784,582, filed on Dec. 24, 2018.
(60) Provisional application No. 62/679,051, filed on Jun. 1, 2018.
(60) Provisional application No. 62/654,718, filed on Apr. 9, 2018.
(60) Provisional application No. 62/654,859, filed on Apr. 9, 2018.
(60) Provisional application No. 62/552,747, filed on Aug. 31, 2017.
(60) Provisional application No. 62/654,859, filed on Apr. 9, 2018.

(51) Int. Cl. F03B 13/06; F15B 1/26

(52) U.S. Cl. CPC F03B 13/06; F15B 1/265

(57) ABSTRACT

Disclosed techniques include energy storage and buffering using multiple pressure containers. Liquid and gas are pumped into a subterranean container. The liquid and gas are pressurized in the subterranean container. A pump is coupled to the subterranean container to accomplish the pressurizing of the subterranean container. The pump and the subterranean container are coupled to an above-ground pressure vessel. The above-ground pressure vessel is pressurized using the pump. The above-ground pressure vessel receives excess flow from the pump beyond the flow provided to the subterranean container. The above-ground pressure vessel provides buffering for pressure flowing into or out of the subterranean container. The gas includes air and the liquid includes water. Pressure is extracted from the first subterranean container to drive a turbine. The pressure from the above-ground pressure vessel supplements pressure from the subterranean container to drive the turbine at a substantially constant rate.

### RELATED APPLICATIONS

This application claims the benefit of U.S. provisional patent applications “Energy Storage and Buffering Using Multiple Pressure Containers” Ser. No. 63/152,357, filed Feb. 23, 2021, “Gas Liquefaction Using Hybrid Processing” Ser. No. 63/178,560, filed Apr. 23, 2021, “Recovery of Work from a Liquefied Gas Using Hybrid Processing” Ser. No. 63/227,499, filed Jul. 30, 2021, and “Hybrid Compressed Air Energy Storage System Using Paired Liquid Pistons” Ser. No. 63/246,813, filed Sep. 22, 2021.

This application is also a continuation-in-part of U.S. patent application “Energy Management Using a Converged Infrastructure” Ser. No. 16/747,843, filed Jan. 21, 2020, which claims the benefit of U.S. provisional patent applications “Energy Management Using a Converged Infrastructure” Ser. No. 62/795,140, filed Jan. 22, 2019, “Energy Management Using Electronic Flywheel” Ser. No. 62/795,133, filed Jan. 22, 2019, “Energy Transfer Through Fluid Flows” Ser. No. 62/838,992, filed Apr. 26, 2019, and “Desalination Using Pressure Vessels” Ser. No. 62/916,449, filed Oct. 17, 2019.

The U.S. patent application “Energy Management Using a Converged Infrastructure” Ser. No. 16/747,843, filed Jan. 21, 2020 is also a continuation-in-part of U.S. patent application “Energy Storage and Management Using Pumping” Ser. No. 16/378,243, filed Apr. 8, 2019, which claims the benefit of U.S. provisional patent applications “Modularized Energy Management Using Pooling” Ser. No. 62/654,718, filed Apr. 9, 2018, “Energy Storage and Management Using Pumping” Ser. No. 62/654,859, filed Apr. 9, 2018, “Power Management Across Point of Source to Point of Load” Ser. No. 62/679,051, filed Jun. 1, 2018, “Energy Management Using Pressure Amplification” Ser. No. 62/784,582, filed Dec. 24, 2018, “Energy Management Using a Converged Infrastructure” Ser. No. 62/795,140, filed Jan. 22, 2019, and “Energy Management Using Electronic Flywheel” Ser. No. 62/795,133, filed Jan. 22, 2019.

The U.S. patent application “Energy Storage and Management Using Pumping” Ser. No. 16/378,243, filed Apr. 8, 2019, is also a continuation-in-part of U.S. patent application “Energy Management with Multiple Pressurized Storage Elements” Ser. No. 16/118,886, filed Aug. 31, 2018, which claims the benefit of U.S. provisional patent applications “Energy Management with Multiple Pressurized Storage Elements” Ser. No. 62/552,747, filed Aug. 31, 2017, “Modularized Energy Management Using Pooling” Ser. No. 62/654,718, filed Apr. 9, 2018, “Energy Storage and Management Using Pumping” Ser. No. 62/654,859, filed Apr. 9, 2018, and “Power Management Across Point of Source to Point of Load” Ser. No. 62/679,051, filed Jun. 1, 2018.

Each of the foregoing applications is hereby incorporated by reference in its entirety.

### FIELD OF ART

This application relates generally to energy manipulation and more particularly to energy storage and buffering using multiple pressure containers.

### BACKGROUND

Energy demand is significantly increasing due directly to the growth of municipalities, counties, states, and countries. Transportation and electrical needs have experienced some of the most dramatic energy usage increases, in part due to expanded use of electric vehicles such as cars, buses, trucks, and trains. Further, living standards improvements in rural and underdeveloped areas, including expanding and extending electrical and communications infrastructures in or to these areas, and the expansion of transportation networks, have accelerated energy demand growth. Growing populations also cause increases in energy demand as more people consume energy for bathing, cleaning, cooking, laundry, and entertaining. Energy is further consumed for illuminating, heating, and cooling houses or apartments, businesses, and government buildings. Economic growth in sectors such as retail, public transportation, and manufacturing, among many others, increases energy demand. Many countries are actively reducing their energy demands or “carbon footprints”. These countries are overhauling their energy supply and demand infrastructures by undertaking energy efficiency improvements and investing in renewable energy sources. Other countries, however, are continuing to invest in environmentally damaging energy sources such as fossil fuel burning power plants, hydro dams, and other traditional and controversial energy generation sources. Interestingly, construction of nuclear facilities is being undertaken or reconsidered after decades of legal wrangling and popular protests.

The many energy stakeholders include energy producers and energy consumers. Energy producers include those that use both traditional and renewable energy sources, while energy consumers include government agencies, business and industry, and domestic consumers. Socially and environmentally conscious energy consumers endeavor to reduce their energy consumption and cost. These consumers are actively initiating, practicing, and enforcing energy conservation measures for powerful environmental and economic reasons. Consumers can decrease their energy footprints and associated costs by moderating their heating, cooling and lighting habits; rescheduling processing and manufacturing jobs to run at low energy cost times; and purchasing energy-efficient appliances and machines, electronic consumer products, and automobiles. These and other intentional conservation efforts are generally helpful, but the demand for energy of all types continues to increase beyond what energy conservation alone can accomplish. Human population growth increases the demand for energy of all kinds, leading to what many analysts label an energy crisis. Clearly, addressing increasing energy demand is a complex problem. Increased demand for and overconsumption of energy is straining natural and renewable resources alike, resulting in fuel shortages, higher energy costs, and increased environmental destruction and pollution. Further, environmental events such as forest fires, severe cold, excessive heat, and violent storms further affect both the supply of and the demand for energy. Energy distribution deficiencies and inefficiencies present nettlesome obstacles to solving the energy crisis. The existing energy distribution infrastructure is at or over capacity, thus rendering the infrastructure inaccessible to renewable sources. There is adamant, vociferous, and increasingly violent opposition to siting mountaintop or offshore wind turbines, solar farms, or wood burning plants. Even if designs can be drafted and permits obtained to construct renewable energy sources, the distribution of the energy is stymied by the antiquated infrastructure. Commissioning new energy generation facilities remains a seemingly insurmountable challenge.

### SUMMARY

As worldwide energy usage continues to grow, so do energy needs. The need for a reliable and resilient energy supply, as well as the need for grid modernization, is increasing. Access to diverse and secure energy sources is critical. Clean and inexpensive energy is desired, not just in urban areas, but also in remote locations where micro-grid solutions can be favorable. Energy storage and generation provides a solution to these energy needs. Storage and generation technology provides backup power, levels loads, and offers energy management, which can strengthen and stabilize the power grid. Unfortunately, industrial design and architecture of energy storage and generation systems are labor intensive, iterative, and expensive. A hopeful alternative uses naturally occurring structures to accomplish energy storage and transfer. Energy transfer into and out of existing and naturally occurring structures such as subterranean containers and caverns can be accomplished by pressurizing gas and liquid that is transferred into the subterranean containers. The stored energy can be extracted from the subterranean containers by extracting the liquid or gas and using the liquid or gas to operate a turbine. Since the turbine performs most efficiently at an optimum operating point, an above-ground pressure vessel can be used to buffer the pressurized liquid and gas that is extracted. The buffering can provide an “energy capacitance”, whereby a constant pressure can be provided to the turbine. The constant pressure provided to the turbine enables the optimum operation of the turbine.

Disclosed techniques address energy storage and buffering using multiple pressure containers. Liquid and gas are pumped into a subterranean container. Energy such as excess energy or renewable energy is stored by pressurizing the liquid and gas using a pump. The pump can also be coupled to an above-ground pressure vessel, where the pump is used to pressurize the above-ground storage vessel. The pressurized liquid and gas in the subterranean container and the pressurized liquid and gas in the above-ground pressure vessel are used to operate a turbine at an optimal operating point. The turbine can be used to spin a generator or alternator, thereby converting the energy stored by the pressurized gas and liquid into energy such as electrical energy. The pumping, the pressurizing the first subterranean container, the pressurizing the first above-ground pressure vessel, and the valves are computer controlled.

A method for energy manipulation is disclosed comprising: pumping liquid and gas into a first subterranean container; pressurizing the liquid and gas in the first subterranean container, wherein the pressurizing is accomplished using a first pump coupled to the first subterranean container; coupling the first pump and the first subterranean container to a first above-ground pressure vessel; and pressurizing the first above-ground pressure vessel using the first pump, wherein the first above-ground pressure vessel receives excess flow from the first pump, which is beyond the flow provided to the first subterranean container. In embodiments, the first above-ground pressure vessel provides buffering for pressure flowing into or out of the first subterranean container. The buffering, which can include sourcing pressure to supplement pressure extracted from the subterranean container or sinking pressure to capture excess pressure extracted from the subterranean container, can enable the constant operating point of the turbine. Further embodiments include pressurizing a second system, comprising a second subterranean container, a second above-ground pressure vessel, and a second pump, from the first subterranean container. Energy stored as pressure in the first system can be transferred to the second system.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for energy storage and buffering using multiple pressure containers.

FIG. 2 illustrates a system block diagram for a constant pump operating point.

FIG. 3 is a system block diagram for a constant turbine operating point.

FIG. 4 illustrates power generation and power storage cycles.

FIG. 5 is a system block diagram showing an above ground water reservoir.

FIG. 6 shows multiple subsurface reservoirs.

FIG. 7 is a block diagram for energy management.

FIG. 8 illustrates an energy internet block diagram.

FIG. 9 shows a software-defined water piston heat engine (WPHE).

FIG. 10 shows energy storage and recovery.

FIG. 11 illustrates a water piston heat engine.

FIG. 12 is a system diagram for energy storage and buffering using multiple pressure containers.

### DETAILED DESCRIPTION

This disclosure provides techniques for energy manipulation. Energy manipulation can be based on storing energy and recovering energy, where the energy recovery can occur at a later time. The later time can include a short-term basis such as minutes, hours, or days; a long-term basis such as weeks, months, years, decades; and so on. The energy can be stored by pumping liquid and gas into a container such as a subterranean container, where the subterranean container can include a cavern, a dome, a cave, or another structure. The subterranean container can include a pressure vessel. The pumping can be accomplished using a pump, a pump-turbine, a water pressure heat engine (WPHE), and the like. The pressure vessel can include unused oil infrastructure such as an unused or “dry” oil well. The liquid and gas can be pressurized within the container. An above-ground pressure vessel can be coupled to the subterranean container and the pump, and the above-ground pressure vessel can be pressurized. The pressures within the subterranean container and the above-ground pressure vessel can be substantially similar or substantially different.

Energy is recovered from the subterranean container by allowing liquid and gas from the container to escape. The liquid, the gas, or both, can be used to operate a turbine, where operating the turbine can be used to convert the liquid and gas pressure into energy such as electrical energy. Note that for most efficient operation of the turbine, or of the pump that moves the liquid and the gas, the turbine or the pump is operated at an optimum performance point. The optimum performance point can be achieved by operating the turbine, pump, pump-turbine, etc., using a constant liquid and gas pressure. However, the pressure within the subterranean container can be above the desired pressure for turbine or pump operation, can be below the desired pressure, can provide changing pressure as the container is discharged, and so on. To counteract the pressure fluctuations and to help maintain a constant pressure, the above-ground pressure vessel can provide an energy capacitance function for a system comprising the pump, the subterranean container, and the above-ground pressure vessel. Analogous to the operation of a capacitor within an electrical circuit, the above-ground pressure vessel can absorb or collect excess pressure from the subterranean tank, supplement or provide additional pressure to boost low pressure from the tank, and so on. The result is that a substantially constant pressure can be provided to the turbine so that the turbine can operate at its optimum performance point.

Disclosed techniques include energy manipulation based on energy storage and buffering using multiple pressure containers. Liquid and gas are pumped into a first subterranean container. The liquid and gas are pressurized in the first subterranean container. A first pump is coupled to the first subterranean container to accomplish the pressurizing of the first subterranean container. The first pump and the first subterranean container are coupled to a first above-ground pressure vessel. The first above-ground pressure vessel is pressurized using the first pump wherein the first above-ground pressure vessel receives excess flow from the first pump beyond that flow provided to the first subterranean container. Pressure is extracted from the first subterranean container to drive a first turbine, where the extracting can include taking liquid or taking gas from the first subterranean container. The first above-ground pressure vessel provides buffering for pressure flowing into or out of the first subterranean container. The buffering enables operation of the first turbine at an optimum performance point.

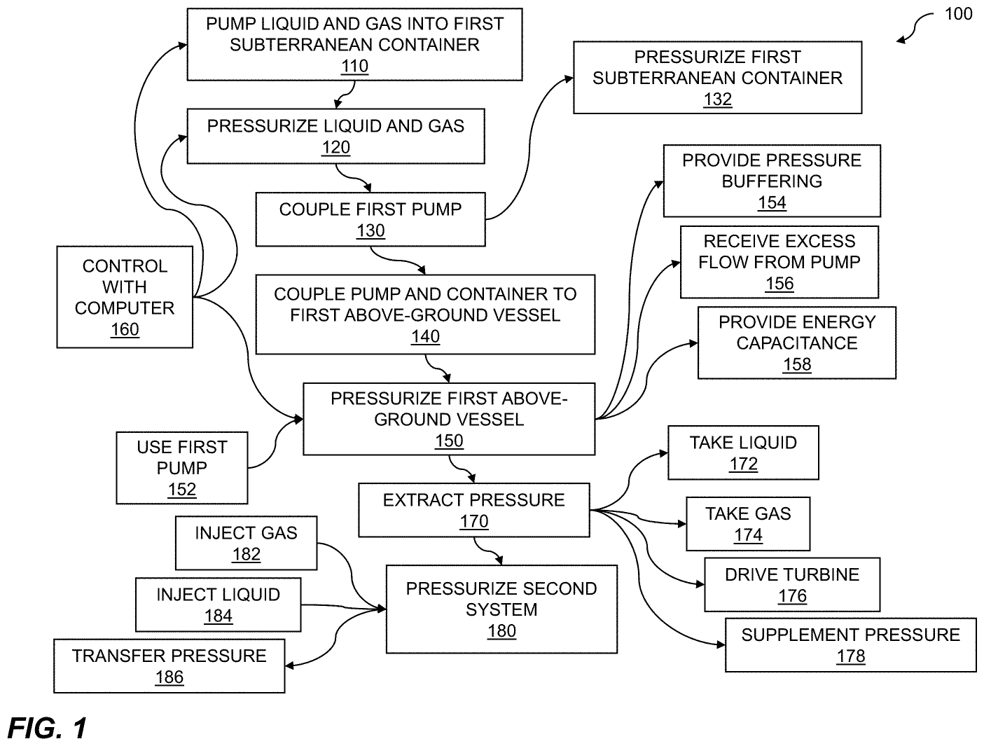

FIG. 1 is a flow diagram for energy storage and buffering using multiple pressure containers. The energy storage and buffering can enable energy manipulation by converting energy such as electrical energy to pressure energy. The pressure energy can be stored in a container such as a subterranean container. The pressure energy, when needed, can be removed from the container and converted by generating electrical energy using a turbine or similar component. The energy manipulation can be part of an energy management system. The energy storage, generation, and management can be based on one or more assemblies, where the one or more assemblies can include fluid-based energy storage and generation assemblies. The fluid-based energy storage and generation assemblies can include a liquid piston heat engine (LPHE) or more specifically, a water piston heat engine (WPHE). The fluid-based energy storage and generation assembly can include multiple pressure vessels such as subterranean containers, above-ground pressure vessels to accommodate fluid expansion or compression, etc. The fluid can include water, liquid air, liquid nitrogen, and the like. The fluid can be used to compress a gas such as air or nitrogen, a specialty gas such as Freon™, and so on. The fluid can be used to move a liquid, such as by using the fluid to spin a pump-turbine. The pump-turbine can be used to move the liquid to pressurize the subterranean container, to create hydraulic head, etc. The fluid in which energy is stored can be used to generate energy. The fluid can be used to spin a turbine, a pump-turbine, and the like. The fluid-based energy can include hot air, liquid air, cold air, or vacuum services. The fluid-based energy storage and generation assemblies can be parts of a large energy storage and generation subsystem. The energy storage and generation subsystem can include further assemblies for storing energy in other forms. The further energy storage and generation subsystems can include multiple batteries or capacitors, pressurized storage elements such as high-pressure water, pressurized air, steam, ice-water slurry, and the like.

The flow 100 includes pumping liquid and gas 110 into a first subterranean container. In embodiments, the first subterranean container includes a subterranean cavern, porous rock structure, or unused well structure. The subterranean container can include a human-made component such as a tank, a high-pressure vessel, a bladder, and so on. The subterranean container can include a naturally occurring geological structure. In other embodiments, the first subterranean container can include unused infrastructure such as an unused or depleted oil well. A variety of liquids and gases can be pumped in the first subterranean container. In embodiments, the liquid includes water. The water can include fresh water, gray water, and the like. In other embodiments, the gas includes air. Other gases, such as nitrogen, a specialty gas such as Freon™, etc., can be used. The flow 100 includes pressurizing the liquid and gas 120 in the first subterranean container. The pressuring the liquid and the gas in the first subterranean container can be accomplished by adding liquid, adding gas, or adding both liquid and gas. The pressurizing the liquid and the gas can be accomplished by adding air or another gas, adding water or another liquid, and so on. The flow 100 includes coupling a first pump 130 to the first subterranean container. The pump can include an electrically operated pump, a pump-turbine that can be operated by a gas or a liquid, and so on. In embodiments, the pump can include a liquid piston heat engine. In the flow 100, the pump accomplishes the pressurizing 132 of the first subterranean container. The pump can be used to transfer gas, liquid, or both gas and liquid into the subterranean container. In embodiments, the first pump pumps the liquid. The pump can pump water or another liquid into the container. In other embodiments, the first pump pumps the gas. The gas can include air, nitrogen, or other gas.

The flow 100 includes coupling the first pump and the first subterranean container to a first above-ground pressure vessel 140. The above-ground pressure vessel can include energy storage elements such as high-pressure chambers, compression-expansion chambers, compressed air chambers, and so on. While above-ground pressure vessels are discussed, the pressure vessels can be located below ground, submerged in water, etc. The above-ground pressure vessel can be of a size substantially similar to the subterranean container, or a size substantially dissimilar to the container. In embodiments, the first subterranean container can be larger than the first above-ground pressure vessel. The flow 100 includes pressurizing the first above-ground pressure vessel 150. The pressurizing of the first above-ground tank can be accomplished using a pump, a pump-turbine, a liquid or water piston heat engine, and so on. In the flow 100, the pressurizing uses the first pump 152. An additional pump can also be used. In the flow 100, the first above-ground pressure vessel provides buffering 154 for pressure flowing into or out of the first subterranean container. The pressure buffering can be used to maintain a constant pressure, to absorb excess pressure, to supplement low pressure, and the like. Discussed below, constant pressure can be used to operate a turbine at an optimum performance point. An optimum performance point can also be determined for the first pump. In embodiments, the first pump can run at substantially constant flow while providing pressure to the first subterranean container and first above-ground pressure vessel. In the flow 100, the first above-ground pressure vessel receives excess flow 156 from the first pump beyond that flow provided to the first subterranean container. The receiving excess flow can include a check or safety technique to protect the subterranean container and the above-ground pressure vessel.

In embodiments, the first above-ground pressure vessel can provide flow to the first subterranean container when pressure is higher in the above-ground pressure vessel. The providing flow can accomplish pressure equalization between the subterranean container and the above-ground pressure vessel. In embodiments, the first above-ground pressure vessel can provide an energy capacitance function for a system comprising the pump, the first subterranean container, and the first above-ground pressure vessel. The energy capacitance function can provide pressure when the container pressure is below a desired pressure. In embodiments, valves can control flow into and out of the first subterranean container. The valves can include bidirectional valves, directional valves, solenoid-controlled valves, and so on. In the flow 100, the above-ground pressure vessel can provide an energy capacitance function 158 for a system comprising the pump, the subterranean container, and the above-ground pressure vessel. The capacitance function can maintain a steady pressure by receiving the excess flow from the pump, providing flow, and so on.

In the flow 100, the pumping, pressurizing the first subterranean container, the pressurizing the first above-ground pressure vessel, and the valves are computer controlled 160. The computer control can be accomplished using a computer, a processor, a controller, a microcontroller, a core within an integrated circuit such as an application specific integrated circuit (ASIC), a core within a programmable device such as a field programmable gate array (FPGA), and so on. The flow 100 further includes extracting pressure 170 from the first subterranean container to drive a first turbine. The first turbine can include a stand-alone turbine, a pump-turbine, a WPHE, and so on. The turbine can be operated by providing a liquid or a gas to the turbine. In the flow 100, the extracting pressure can be accomplished by taking liquid 172 from the first subterranean container. The liquid that is taken can include water, liquid air, liquid nitrogen, and the like. In the flow 100, the extracting pressure is accomplished by taking gas 174 from the first subterranean container. The gas can include air, nitrogen, Freon™, and so on. The pressure that is extracted can include pressure within the subterranean container and the above-ground pressure vessel. In the flow 100, pressure from the first subterranean container is provided to the above-ground pressure vessel to enable driving of the turbine 176 at a substantially constant rate. The substantially constant driving rate of the turbine can include an optimum performance point or rate. In the flow 100, pressure from the first above-ground pressure vessel supplements pressure 178 from the first subterranean container to drive the turbine at a substantially constant rate. Supplemental pressure from the first above-ground pressure vessel is used to maintain a substantially constant pressure at the turbine, thus driving the turbine at the substantially constant rate. In embodiments, the first above-ground pressure vessel can provide an energy capacitance function for a system comprising the turbine, the first subterranean container, and the first above-ground pressure vessel. The capacitance function can “flatten out” energy peaks and valleys, thus enabling a substantially constant pressure to the turbine.

The flow 100 further includes pressurizing a second system 180, comprising a second subterranean container, a second above-ground pressure vessel, and a second pump, from the first subterranean container. The second system can be operated separately from the first system, in parallel with the first system, and so on. The second system can act as a backup to the first system, a spare system, an overflow system, etc. In the flow 100, the pressurizing the second system is accomplished by injecting the gas 182 from the first subterranean container. The gas from the first subterranean system can include air, nitrogen, Freon™, and so on. In the flow 100, the pressurizing is accomplished by injecting the liquid 184 from the first subterranean container. The liquid from the first subterranean container can include water or another liquid. In embodiments, the pressurizing the second subterranean container can accomplish energy storage. The pressure in the second subterranean container can include a pressure that is substantially similar to the pressure in the first subterranean container. In other embodiments, the second subterranean container can be pressurized at higher pressure than the first subterranean container. The second subterranean container can be pressurized using the second pump. A pressure differential between the first and the second subterranean containers can be accomplished by locating the first and second subterranean containers at different depths below ground surface. The flow 100 further includes transferring pressure 186 from the second subterranean container to the first subterranean container to generate energy. The transferring can be accomplished using a pump, a pump-turbine, and so on. In embodiments, the transferring can be accomplished based on hydraulic head. In embodiments, the second above-ground pressure vessel can provide an energy capacitance function during the transferring. The energy capacitance function can maintain a constant flow between the second subterranean container and the first subterranean container. In other embodiments, the first above-ground pressure vessel can provide an energy capacitance function during the transferring. The first and second above-ground pressure vessels can provide an energy capacitance function in tandem or independently. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

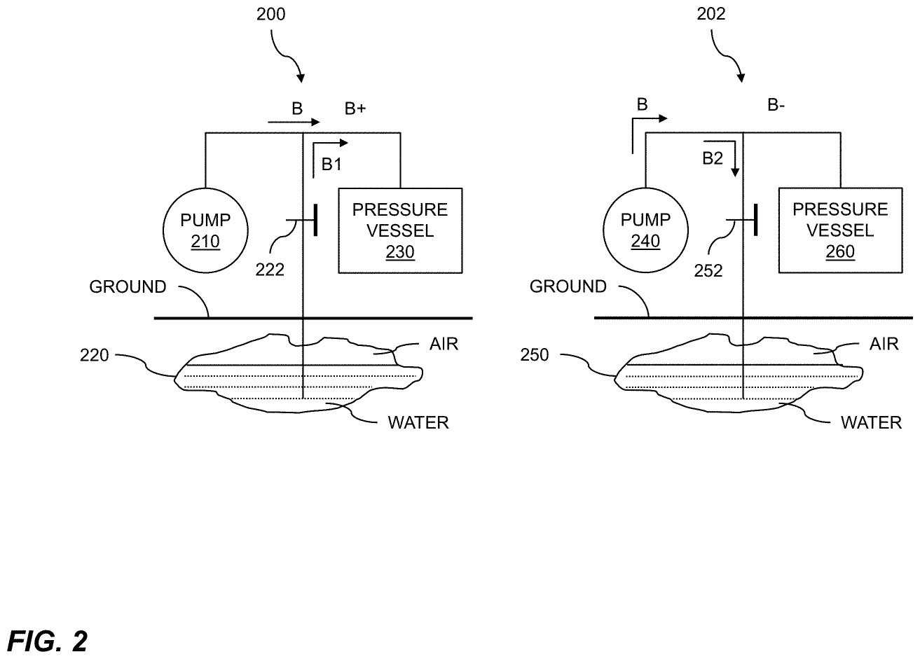

FIG. 2 illustrates a system block diagram for a constant pump operating point. A pump can be coupled to a subterranean container and to an above-ground pressure vessel. The pump can operate at an optimum performance or constant operating point in order to maximize pumping efficiency, to minimize power consumption, and so on. The pump can be used to pressurize the subterranean container and the above-ground pressure vessel to a desired pressure for storing energy. The energy can include renewable or intermittent energy, surplus energy, inexpensive energy, and so on. A constant pump operating point can enable energy storage and buffering using multiple pressure containers.

In example system 200, a pump 210 that can pump a gas, a liquid, or both gas and liquid is shown. The pump is coupled to a subterranean container 220 and to an above-ground pressure vessel, or tank, 230. The subterranean container and the above-ground pressure tank contain a liquid such as water and a gas such as air. Other gases or liquids can also be used within the container and the vessel. Access of the liquid or the gas pumped by the pump can be regulated using a valve 222. Setting the valve 222 can be used to set a target flow into the subterranean container, to control a rate of pressurization, and so on. The amount of liquid and gas pumped by the pump represents an amount of power to be stored within the container and the vessel. When the amount of power available from power sources exceeds present power demand, a net power surplus exists. As a result, the excess flow, B+, can pressurize liquid and gas in the pressure vessel 230. An example system 202 shows the case as the amount of excess power decreases. Flow from the pump 240 can be directed to the subterranean container 250 through valve 252. Since the amount of flow to the above-ground pressure vessel 260 is decreased by an amount directed to the subterranean container, the amount of flow to the above-ground pressure tank can decrease, become zero, or can reverse by providing supplemental flow to the flow provided by the pump.

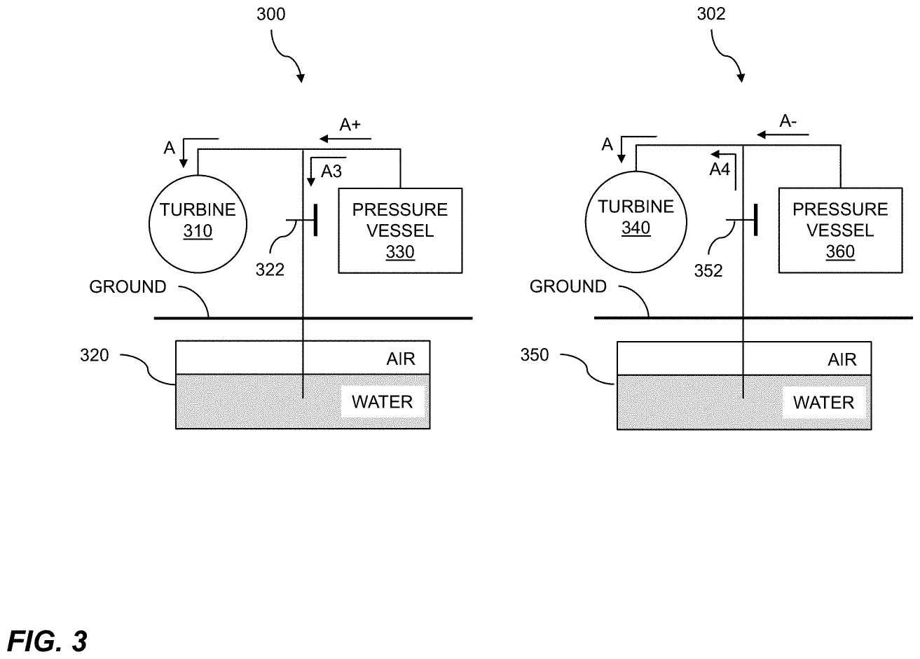

FIG. 3 is a system block diagram for a constant turbine operating point. Stored energy can be recovered by using the stored energy directly, by converting the stored energy to a different type of energy, and so on. The stored energy can be recovered by using a flow of liquid or gas to drive a turbine, where the turbine can be operated at a constant operating point, such as an optimum performance point. Operating a turbine at a constant turbine operating point enables energy storage and buffering using multiple pressure containers. Example 300 shows a flow A that can maintain a constant turbine operating point at turbine 310. The flow A comprises a flow A+ drawn from pressure vessel 330 minus flow A3 which is directed through valve 322 to subterranean container 320. Flow A3 can represent a positive net power generation amount. Example 302 shows the effect of increasing net power generation. When the flow A− of liquid, gas, or both liquid and gas that is provided by the pressure vessel 360 is less than the amount of flow A needed to maintain a constant turbine 340 operation point, then flow A4 can be provided by subterranean container 350 through valve 352. In embodiments, the above-ground pressure vessel can provide an energy capacitance function for a system comprising the turbine, the first subterranean container, and the first above-ground pressure vessel. Energy capacitance by the pressure vessel can “smooth out” the flow from the subterranean container. Subterranean containers 320 and 350 can be formed out of naturally occurring geologic features, such as an underground cave or cavern, can be formed out of manmade underground features, such as a drilled well or an excavated mine, or can be formed out of a combination of both naturally occurring features and manmade features.

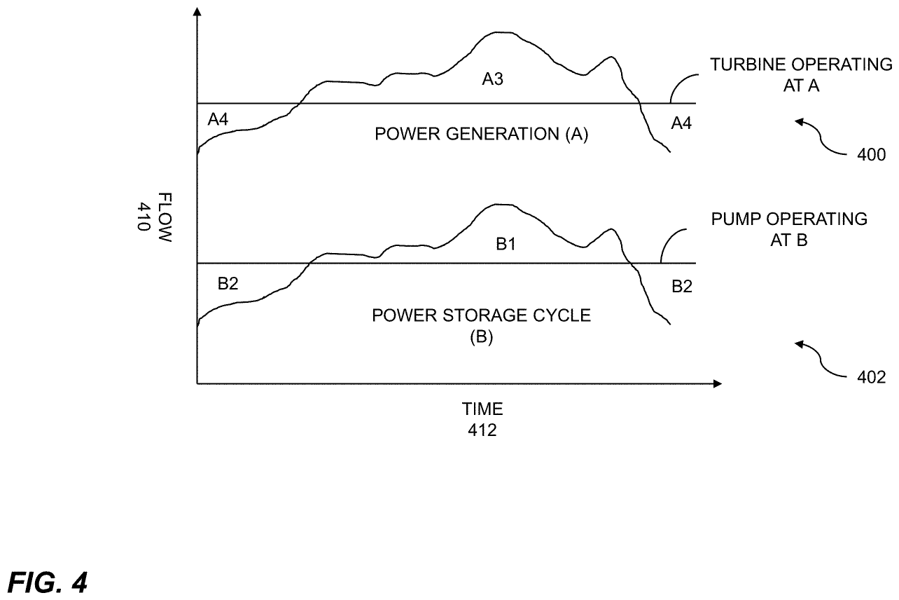

FIG. 4 illustrates power generation and power storage cycles. Discussed throughout, power that is in excess to power needs at a given time can be stored for later use. Power can also be stored based on availability of power such as renewable power from solar, wind, tidal, or wave action; cost of the power; and so on. Power generation can be based on operating a turbine at an optimum performance point, while power storage can be based on operating a pump at an optimum performance point. Power generation and power storage cycles are enabled by energy storage and buffering using multiple pressure containers. Flow 410 versus time 412 is shown for power generation 400. A turbine operating point is chosen, where the turbine operating point can include a turbine optimum performance point. The turbine can be coupled to an alternator, generator, and so on, to convert the flow into electrical power. Since an amount of power needed varies over time due to fluctuations in power demands, the amount of flow of liquid or gas also changes over time. The flow A can be provided from an above-ground pressure vessel, a subterranean container, or both. When the amount of flow provided by the pressure vessel is less than the amount of flow required to operate the turbine at its desired operating point, the flow can be supplemented by flow A4 from the subterranean container. Alternatively, when the amount of flow provided by the pressure vessel is greater than the amount of flow required to operate the turbine at its desired operating point, then the excess flow A3 can be directed to the subterranean container.

Flow 410 versus time 412 is shown for power storage 402. A pump operating point is chosen, where the pump operating point can include a pump optimum performance point. The pump can include an electrical pump, a pump-turbine, a liquid piston heat engine, and so on. The pump can convert energy such as electrical energy into a fluid flow. Since an amount of generated power varies over time due to availability of power such as power from renewable sources, cost of power, and so on, the amount of liquid or gas pumped by the pump also changes over time. The flow B can be provided by the pump to an above-ground pressure vessel, a subterranean container, or both. When the amount of flow required to pressurize the above-ground pressure vessel is greater than the flow associated with the pump operating point, a portion of the flow B2 can be directed to the subterranean storage container. Alternatively, when the amount of flow provided by the pump is less than the amount of flow required to pressurize the pressure vessel, then a flow B1 can be provided from the subterranean container.

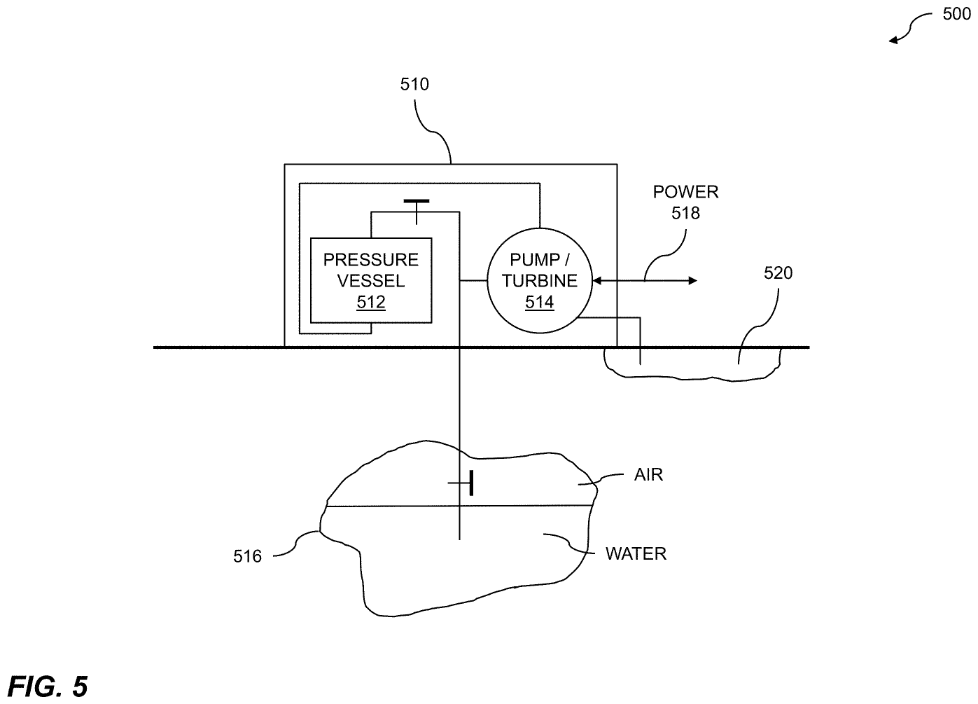

FIG. 5 is a system block diagram showing an above-ground water reservoir 500. Excess, low cost, or other energy can be stored for later use. The energy to be stored can be converted from one energy type such as electrical energy to a different energy type such as pressurized liquid and gas. The pressurized liquid and gas can be stored in an above ground pressure vessel and a subterranean container. The liquid can include water, and the gas can include air. In order to convert the energy stored as pressurized liquid and gas back to electrical energy, liquid or gas can be taken from the pressure vessel and the container and used to drive a turbine. When liquid is extracted and used to drive the turbine, the “waste” water can be shunted to an above-ground water reservoir. When the pressure vessel or the subterranean container requires re-pressurization in order to store energy, water can be drawn from the above-ground reservoir and pumped into the above-ground pressure vessel, the subterranean container, or both. Using the above-ground water reservoir enables energy storage and buffering using multiple pressure containers.

A system block diagram that includes an above-ground water reservoir is shown. The block diagram 500 includes a system 510 for pressurizing liquid and gas and for converting energy stored as the pressurized liquid and gas to another energy type such as electrical or other power 518. The system comprises a pressure vessel 512 and a pump-turbine 514. The system further includes a subterranean container 516, where the container can hold pressurized liquid and gas. In embodiments, the liquid includes water, and the gas includes air. Liquid or air can be removed from the subterranean container and the pressure vessel to drive the pump-turbine. Driving the pump-turbine can be used to convert the energy stored as pressure to another energy type such as electrical energy. When liquid is removed, the liquid can be discharged into an above-ground water reservoir 520 after driving the pump-turbine. When energy is to be stored, water can be pumped from the above-ground reservoir. The pumped water can be directed to the above-ground pressure vessel and the subterranean container. The pumping of the water can repressurize the vessel and the container.

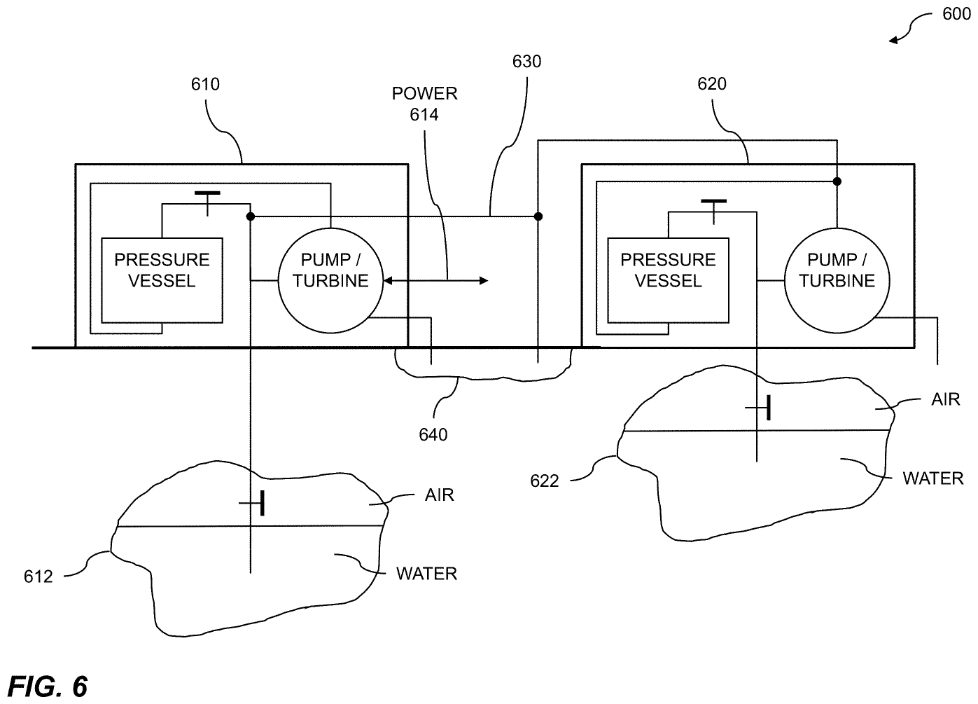

FIG. 6 shows multiple subsurface reservoirs. Discussed above and throughout, a subterranean container can be used to store pressurized liquid and gas. The pressurized liquid and gas can be extracted from the subterranean container and then used to drive a turbine. The driven turbine can be used to generate electrical energy. The subterranean container can be a component within a system for energy storage and recovery. In embodiments, multiple subsystems that include subterranean containers enable energy storage and buffering for energy manipulation.

An example of two energy storage subsystems that include subterranean containers is shown 600. The first subsystem 610 includes an associated subterranean container 612, and a second subsystem 620 includes an associated subterranean container 622. Note that the subterranean containers 612 and 622 are at different depths beneath ground surface. The difference in depths can include an elevation H. The first subsystem can pressurize its associated subterranean container, and the second subsystem can pressure its associated subterranean container to the same pressure or to different pressures. In embodiments, the pressurizing the second system can be accomplished by injecting the gas from the first subterranean container. The injecting the gas can be accomplished using a direct connection 630 between the first subsystem and the second subsystem. In other embodiments, the pressurizing can be accomplished by injecting the liquid from the first subterranean container. The subsystems 610 and 620 can be used individually or together for energy storage. In a usage example, the subsystems can be used individually to generate energy such as electrical energy by extracting liquid from the subterranean containers. After driving the turbine associated with each subsystem, the liquid can be discharged into the surface reservoir 640. In embodiments, the second subterranean container can be pressurized at higher pressure than the first subterranean container. Further embodiments include transferring pressure from the second subterranean container to the first subterranean container to generate power 614. The transferring of pressure can be accomplished using one or more pump-turbines. The transferring can be based on hydraulic head, where the hydraulic head is based on the differences in elevation H between the two subterranean containers.

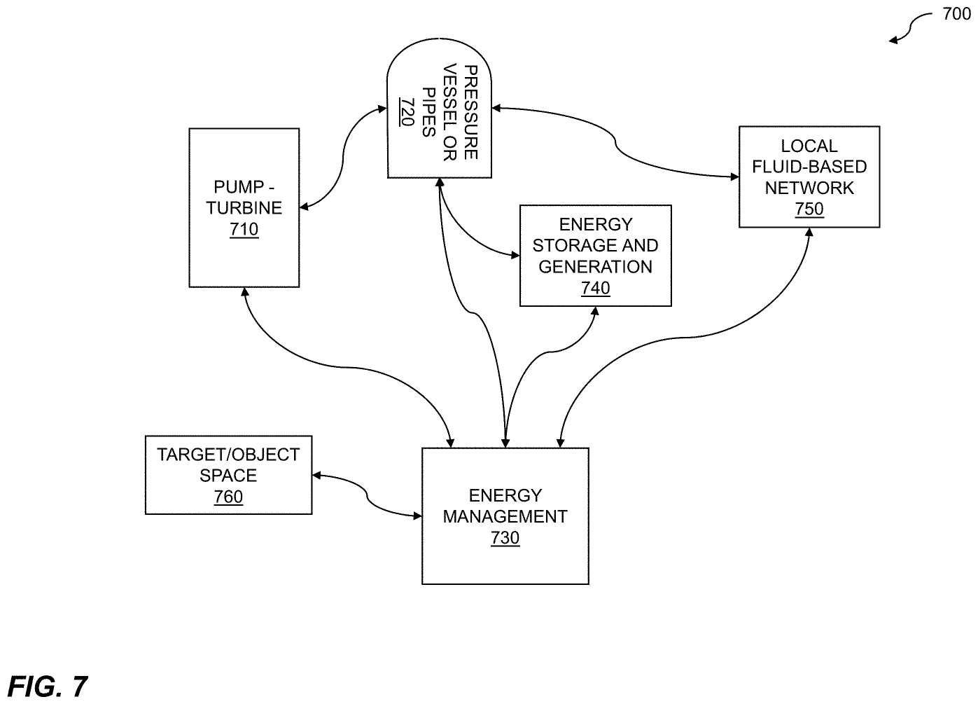

FIG. 7 is a block diagram for energy management. Energy management can be based on computer control. The computer control can include software-defined mechanical machines, where the software-defined mechanical machines are described using a description language, a high-level language, and so on. The software-defined machines can describe utilizing a liquid to compress a gas, utilizing a gas to pressurize a liquid, and so on. The machines can include a converged infrastructure, where the converged infrastructure can include fluid-based assemblies for energy storage and generation. The fluid-based assemblies can include assemblies that use the compressed gas or the pressurized liquid for energy storage and buffering, where the energy storage and buffering uses multiple pressure containers. Liquid and gas are pumped into a first subterranean container. The liquid and gas are pressurized in the first subterranean container. A first pump is coupled to the first subterranean container to accomplish the pressurizing of the first subterranean container. The first pump and the first subterranean container are coupled to a first above-ground pressure vessel. The first above-ground pressure vessel is pressurized using the first pump, wherein the first above-ground pressure vessel receives excess flow from the first pump beyond that flow provided to the first subterranean container. Energy management 700 can include a pump-turbine 710. In embodiments, the pump-turbine can comprise separate pump and turbine components, a combined pump-turbine component, etc. The pump-turbine can be coupled to a vessel. The vessel can comprise a pressure vessel or pressure pipes 720. Energy management can include more than one pump-turbine/pressure vessel or pressure pipes assembly. The pressure vessel can include an air compression tank, a cavern, unused oil infrastructure, and so on. The pressure pipes can include pressure amplification pipes.

The pump-turbine/pressure vessel or pipes assembly can be connected to an energy management component 730. The energy management component can include an energy control management system, where the energy control management system can include software that can be executed on one or more processors. The energy management component can be coupled to energy storage and generation 740. Various types of energy, such as electrical energy, chemical energy, thermal energy, kinetic energy, potential energy, etc., can be stored. Energy storage such as electrical energy storage can include batteries, capacitors, and so on. Fluid-based energy storage and generation assemblies can include multiple parallel pipes to accommodate fluid expansion or compression. The energy management can control the pump of the pump-turbine. In embodiments, at least one of the one or more fluid-based energy storage and generation assemblies includes a pump running at an optimum performance-pressure point. Other energy storage techniques can be used. When the energy being stored is electrical energy, the electrical energy can be converted between direct current (DC) electrical energy and alternating current (AC) electrical energy. Energy storage can be accomplished using flywheels which can be separate from or included as part of a motor or generator.

The energy management can include a local fluid-based network 750. The fluid-based network can include energy management, energy storage and generation, pressure vessels or pressure pipes, pump-turbines, and so on. The local fluid-based network can be used for delivering fluid-based energy. In embodiments, the delivering includes providing local, fluid-based services. The fluid-based services can include domestic services, industrial or manufacturing services, and the like. In embodiments, the local, consumer applications can include a water nozzle, an air nozzle, a water Venturi function, an air Venturi function, a vacuum supply, space heating, a fluid-based rotation, space cooling, hot water, or cold water. The delivering can provide other services such as motion services. In embodiments, the delivering includes providing a fluid-based equivalent mechanical range of motion through fluid transfer. The energy management can include a target/object space 760.

Fluid-based energy transfer can include conveying a fluid flow to a target object or target space. The conveyance of the fluid flow can be accomplished using ducts, pipes, Venturi functions, nozzles, and so on. In embodiments, the conveyance can include two-phase heterogeneous or two-phase homogeneous compression. A pump or pump-turbine can be used to pressurize water for example, where the pressurized water can be used to compress air or other gas. The pump or pump-turbine can be used to compress air or a gas, where the pressurized air or gas can be used to pressurize a liquid such as water.

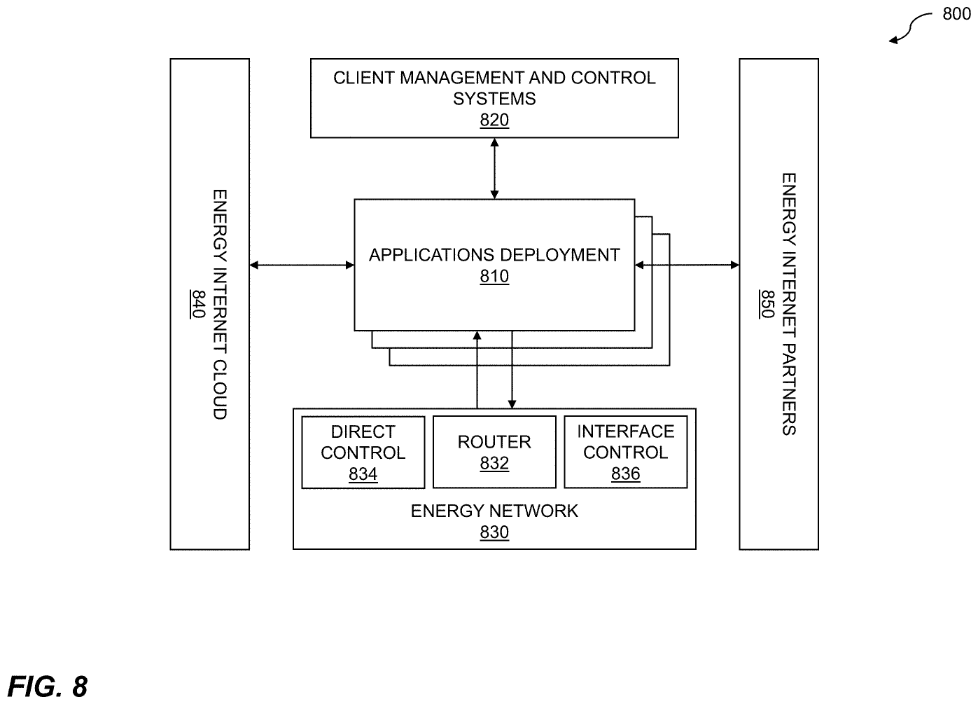

FIG. 8 illustrates an energy internet block diagram. An energy internet 800 enables energy manipulation, where the energy manipulation can be accomplished using energy storage and buffering using multiple pressure containers. Energy manipulation is further based on energy transfer through fluid flows, where the fluids can include compressed, liquefied gases, pressurized liquids, and so on. Liquid and gas are pumped into a first subterranean container. The liquid and gas are pressurized in the first subterranean container. A first pump is coupled to the first subterranean container to accomplish the pressurizing of the first subterranean container. The first pump and the first subterranean container are coupled to a first above-ground pressure vessel. The first above-ground pressure vessel is pressurized using the first pump, wherein the first above-ground pressure vessel receives excess flow from the first pump beyond that flow provided to the first subterranean container. The energy internet can include applications deployment 810. The applications deployment for an energy internet can include a cluster, where the cluster includes one or more application programming interfaces (APIs) for handling data, policies, communications, control, and so on. The data can include energy storage, pump-turbine storage, energy from waterpower, grid energy, etc. The data can include information from energy generators, partners, and so on. The data can further include third-party data from parties including energy consumers such as oil rigs; solar, wind, tidal, or wave-action farms; data centers; and the like.

Applications deployment can communicate with client management and control systems 820. The management can include infrastructure management, microgrid management, operating management, automated controls, and so on. The management can include management of client legacy equipment. The communicating of applications deployment with client management and control systems can include collecting data from one or more points of energy generation, one or more points of energy load, etc. The communicating can further include sending one or more energy control policies. The energy control policies can be based on the energy, energy information, energy metadata, availability of a large-scale energy storage subsystem, and the like. The energy internet can include an energy network 830. The energy network can include one or more energy routers 832, direct control 834, interface control 836, and so on. An energy router 832 can include digital switches for routing energy from a point of energy generation to a point of energy load. An energy router can be coupled to one or more direct control 834 sensors for detecting switch status, point of source status, point of load status, etc. An energy router can be coupled to direct control actuators for steering energy from one or more points of source to a given point of load. An energy router can be further connected to one or more third-party interface control sensors and third-party interface control actuators. The interface control sensors and interface control actuators can be coupled to equipment such as legacy equipment which may not be directly controllable.

The energy internet (EI) can include an energy internet cloud 840. The energy internet cloud can include an energy internet ecosystem, an energy internet catalog, and so on. The energy internet cloud can include an energy internet secure application programming interface (API) through which the EI cloud can be accessed. The EI ecosystem can include third-party applications such as an application or app store, app development and test techniques, collaboration, assistance, security, and so on. The EI cloud can include an EI catalog. The EI catalog can include technology models, plant and equipment information, sensor and actuator data, operation patterns, etc. The EI cloud can include tools or “as a service” applications such as learning and training, simulation, remote operation, and the like. The energy internet can include energy internet partners 850. The EI partners can provide a variety of support techniques including remote management, cloud support, cloud applications, learning, and so on.

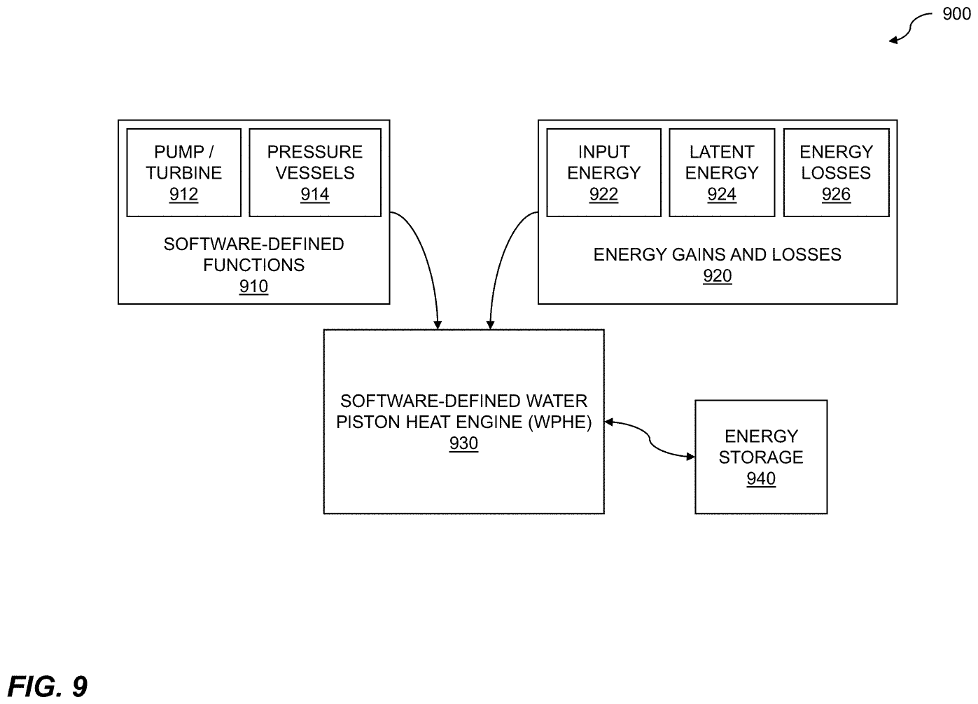

FIG. 9 shows a software-defined water piston heat engine (WPHE). Energy can be generated, stored, recovered, transformed, delivered, and so on, to meet energy load requirements. At times, the energy load requirements can be dynamic. Energy storage can be performed when a surfeit of energy is being generated from energy sources including renewable energy sources such as wind, solar, tidal, wave-action, and so on. The energy can be stored on a short-term basis, such as a length of time substantially less than one week, or on a long-term basis, such as a length of time substantially more than one day. The energy transforming and delivering can be based on energy storage and buffering using multiple pressure containers. Liquid and gas are pumped into a first subterranean container. The liquid and gas are pressurized in the first subterranean container. A first pump is coupled to the first subterranean container to accomplish the pressurizing of the first subterranean container. The first pump and the first subterranean container are coupled to a first above-ground pressure vessel. The first above-ground pressure vessel is pressurized using the first pump wherein the first above-ground pressure vessel receives excess flow from the first pump beyond that flow provided to the first subterranean container. The first above-ground pressure vessel provides buffering for pressure flowing into or out of the first subterranean container.

A software-defined water piston heat engine system 900 is shown. The water piston heat engine includes one or more software-defined functions 910. The one or more software-defined functions can configure or control energy management system components, subsystem components, etc. The software-defined functions can include a pump-turbine function 912. The pump-turbine function can be used to control components such as one or more pumps, one or more turbines, and so on. The pump-turbine function can include one or more pump-turbine subsystems. Embodiments include operating the pump-turbine subsystem at an optimal pressure-performance point for the pump-turbine subsystem. An optimum pressure-performance point can be determined using one or more processors. The pump-turbine function can comprise physical components, moving components, etc. The software-defined functions can include one or more pressure vessels 914. The one or more pressure vessels can be used to store energy within a pressurized fluid, a pressurized gas, and the like. The one or more pressure vessels can include above-ground tanks, below-ground tanks, caverns such as salt caverns, unused oil infrastructure such as unused oil wells, etc.

The water piston heat engine can include energy gains and losses 920. Energy gains can include input energy 922. The input energy can include energy that can be input for storage. The input energy can include grid energy, locally generated energy, renewable energy, and so on. Energy gains can include latent energy 924. Latent energy can be captured from phase changes such as a change from a gas to a liquid, from a liquid to a solid, and so on. The latent energy can be stored. The water piston heat engine can include energy losses. Energy losses 926 can include pressure losses from pressurized vessels, temperature losses, electrical charge leakage, and so on. The system 900 includes a software-defined water piston heat engine (WPHE) 930. The software-defined WPHE can use software to configure the software-defined functions, to control energy storage and recovery, and so on. The WPHE can include an energy management system that can be operated by an energy management control system. The energy management control system can add or remove energy generation subsystems or energy storage subsystems as needed. The energy management control system can support hot swapping of one or more subsystems. Hot-swapping subsystems can include replacing faulty subsystems, swapping out subsystems for maintenance, and the like. In embodiments, the energy management control system can control coupling of the energy, the pump-turbine subsystem, and the one or more pressure amplification pipes. The energy management control system, such as the fluid-based energy management system, includes storing energy for a period of time. The period of time can include a short-term basis or a long-term basis. In embodiments, the short-term basis can be an integer number of seconds, minutes, hours, or days, wherein the integer number of seconds, minutes, hours, or days comprises a length of time substantially less than one week. Other time increments can be used. In other embodiments, the long-term basis can be an integer number of weeks, months, seasons, or years, wherein the integer number of weeks, months, seasons, or years comprises a length of time substantially more than one day.

The system 900 includes energy storage 940. Energy that can be stored can include electrical energy, chemical energy, mechanical energy, fluid energy, gas energy, and so on. Energy can be stored using one or more of the energy storage and generation assemblies. In embodiments, energy storage and generation assemblies comprise multiple, parallel pipes to accommodate fluid expansion or compression. As discussed throughout, the pipes, including the parallel pipes, can include a high-pressure input pipe, a hierarchy of intermediate pressure pipe layers, low pressure storage pipes, and so on. In embodiments, the fluid of the one or more fluid-based energy storage and generation assemblies can include liquid air. Further liquids may also be used within the energy storage and generation assemblies. In other embodiments, the further liquids can include liquid nitrogen, Freon™, and the like.

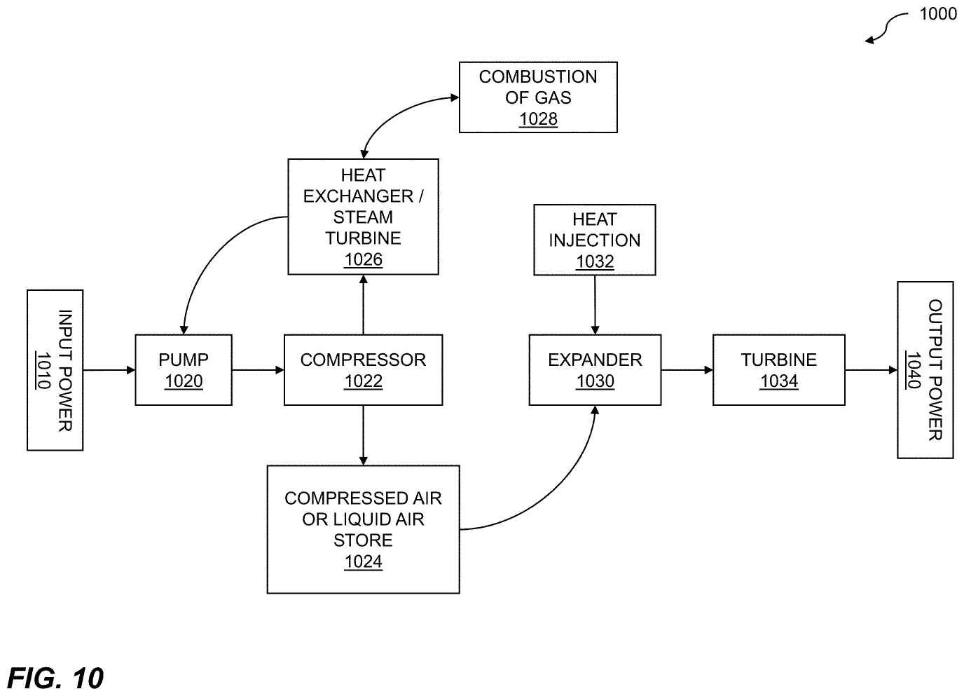

FIG. 10 shows energy storage and recovery 1000. Energy storage and recovery can be based on energy manipulation. Energy manipulation can include energy storage, generation, connection, provision, delivery, and so on. The energy manipulation can be controlled by an energy management component. The energy manipulation can be software controlled. Energy manipulation can include storing energy for a period of time, where the period of time can include a short-term basis, a long-term basis, etc. The stored energy can be recovered and delivered to meet one or more energy load requirements. The energy recovery and delivery can be based on energy load requirements, seasonal adjustments, energy generation and usage policies, service level agreements, and the like. The energy recovery and delivery can be supplemented using energy buffering. Energy storage and buffering using multiple pressure containers enables energy manipulation. Liquid and gas are pumped into a first subterranean container. The liquid and gas are pressurized in the first subterranean container. A first pump is coupled to the first subterranean container to accomplish the pressurizing of the first subterranean container. The first pump and the first subterranean container are coupled to a first above-ground pressure vessel. The first above-ground pressure vessel is pressurized using the first pump, wherein the first above-ground pressure vessel receives excess flow from the first pump beyond that flow provided to the first subterranean container.

Input power 1010 can include energy sources such as grid energy from sources that are derived from coal or natural gas, hydro, and nuclear sources, as well as renewable energy that is derived from sources such as biogas, solar, wind, geothermal, tidal, and wave action. Energy produced from some renewable energy sources can be intermittent. Solar or wind generation relies on the presence of sunlight or wind, respectively. Energy output from solar generation is at a minimum on a cloudy day, and substantially zero at night, while wind generation is substantially zero when the wind is calm. Since energy load requirements persist even in the absence of sunlight or wind, for example, energy storage is required for energy that is generated intermittently. Energy from intermittent sources can be stored. Energy storage can be based on electrical storage, chemical storage, pressure storage, and so on. In embodiments, energy can be stored by using a pump 1020. The pump can include an electrically operated pump, a pump driven by a turbine, and the like. The pump can drive a compressor 1022 which can be used to store energy in various forms. In embodiments, the compressor can be used to store energy as compressed air or liquid air. The compressed air or the liquid air can be collected in a store 1024. The compressor can also be used to generate steam. In embodiments, the compressor can drive a heat exchanger/steam turbine 1026. The steam can be used to spin the turbine, which can be used to operate the pump 1020. Energy, such as excess heat, including latent heat, can be collected using the heat exchanger. In embodiments, the collected energy can be used to preheat compressed air that can then be used to spin a turbine. As for other components related to energy storage and recovery, the heat exchanger/steam turbine can be controlled. The control can be accomplished using software-based management. In embodiments, the controlling can provide heat during expansion through combustion of a gas 1028.

The compressed air or liquid air can be coupled to an expander 1030. The expander can be coupled to a turbine 1034, where the turbine can be spun by the release of the compressed air or liquid air. As compressed air expands or is released, the compressed air cools. The result of the cooling air can be to precipitate out any moisture that may be contained within the compressed air. The precipitating moisture can cause the turbine to freeze or ice up due to an accumulation of frost within the turbine. To prevent icing up of the turbine, heat collected by the heat exchanger can be injected 1032 into the expander 1030. The turbine can be coupled to or can include a generator (not shown). The generator can produce output power 1040. The output power can be used to meet increased power load requirements. The output power can be generated from the stored energy, where the stored energy can be generated by the intermittent power sources. The output power can be generated from the stored energy after a period of time that is assigned on a short-term basis or a period of time that is assigned on a long-term basis.

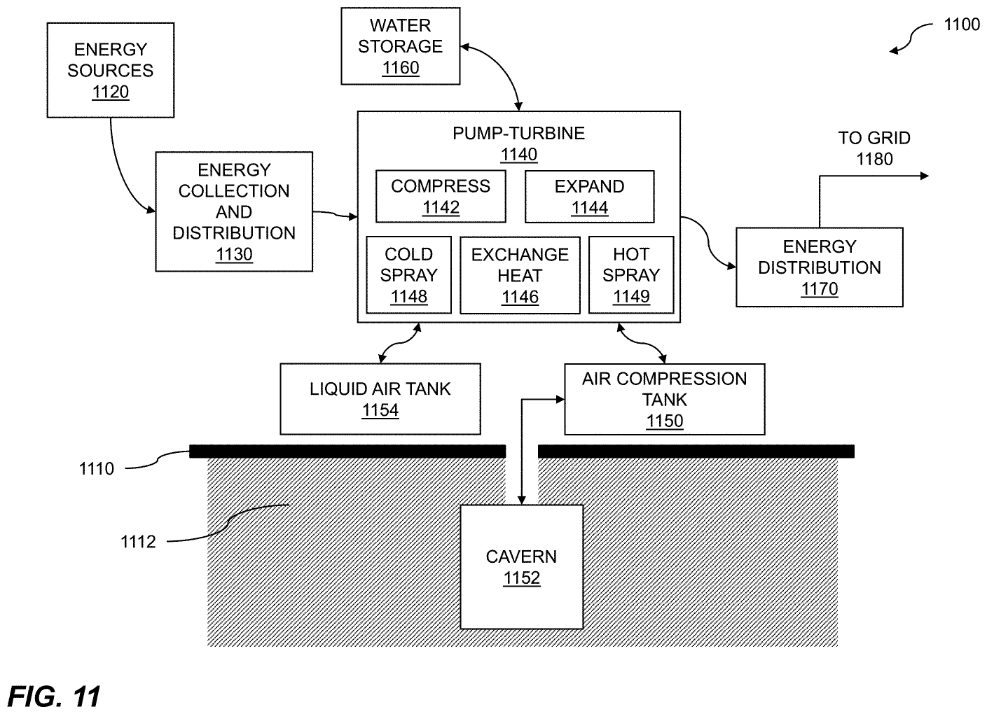

FIG. 11 illustrates a water piston heat engine. A water piston heat engine (WPHE) can be used to pressurize a gas and a liquid, where the gas and the liquid can be stored in multiple pressure containers. Energy storage and buffering using multiple pressure containers enables energy manipulation. Liquid and gas are pumped into a first subterranean container. The liquid and gas are pressurized in the first subterranean container. A first pump is coupled to the first subterranean container to accomplish the pressurizing of the first subterranean container. The first pump and the first subterranean container are coupled to a first above-ground pressure vessel. The first above-ground pressure vessel is pressurized using the first pump wherein the first above-ground pressure vessel receives excess flow from the first pump beyond that flow provided to the first subterranean container.

A water piston heat engine (WPHE) 1100, or a liquid piston heat engine (LPHE), can be used to convert a liquid or a gas that can be provided by a pump or a pump-turbine to a storage format. The storage formats can include solid, liquid, or gas; heat or cold; and so on. As discussed throughout, the WPHE can transform the input energy to a variety of energy storage formats. The functions of the WPHE can be software defined, where the software can operate the WPHE as a compressor, an expander, a heat exchanger, and the like. The WPHE can be positioned on a surface 1110, where the surface can include land 1112; a body of water such as the ocean, a lake or pond, a stream; and so on. The WPHE can include energy sources 1120. The energy sources can include electrical generation from grid sources that can include oil, coal, natural gas, or nuclear; renewable energy sources such as biogas, solar, wind, hydro, geothermal, tidal, or wave action; and the like. The renewable energy sources may be locally available on a microgrid. The energy sources can be obtained and delivered using energy collection and distribution 1130. The energy collection and distribution can include coupling the WPHE to one or more electrical grids, one or more microgrids, etc. The one or more electrical grids, or one or more microgrids, can include redundant energy sources, backup energy sources, and the like.

The energy from the energy sources can be provided to a pump-turbine 1140. The pump-turbine can include a separate pump component and a separate turbine component, a combined single component, etc. The pump-turbine can be used to pressurize a pressure vessel, can be rotated by gas or liquid leaving the pressure vessel, and so on. The pump portion of the pump-turbine can use energy such as electrical energy to spin the turbine. The spinning turbine can be used to move gas or liquid into a vessel such as the pressure vessel, to compress a gas, etc. The turbine portion of the pump-turbine can use energy such as flowing liquid, expanding gas, and the like to spin the pump. In embodiments, the pump can be used to generate energy such as electrical energy. The pump-turbine can perform a variety of operations or functions, where the operations or functions can be software defined. In embodiments, the pump-turbine can include a compression function 1142. The compression function can compress a gas such as air or nitrogen, a specialty gas such as Freon™, etc. The compression function can be accomplished using the pump-turbine, a pump, a turbine, etc. In other embodiments, the pump-turbine can include an expansion function 1144. Gas or liquid can be used to spin a turbine, the pump-turbine, and so on. The gas or liquid can be released from the pressure vessel. The pump-turbine can accomplish other operations. In further embodiments, the pump-turbine can include a heat exchanger 1146. Thermal energy can be generated by compressing a gas. The thermal energy can be captured using a heat exchanger. The pump-turbine can include a cold spray 1148. The cold spray can be used to reduce temperature of the pump-turbine or another component while a gas is being compressed. The pump-turbine can include a hot spray 1149. Thermal energy can be absorbed by an expanding gas. The hot spray can be used to inject thermal energy into the pump-turbine or other components to keep them from “freezing up” if water vapor in the gas condenses.

Discussed throughout, the pump-turbine can pressurize a pressure vessel. In embodiments, the pressure vessel can include an air compression tank 1150. The air compression tank can store a compressed gas such as air or nitrogen, or a specialty gas such as Freon™. The air compression tank can be used to pressurize another tank, cavity, and so on. In embodiments, the air compression tank can be used to pressurize a cavern 1152. The cavern can include a void below ground, a capsule positioned under water, and so on. In other embodiments, the compression tank can be used to pressurize other infrastructure such as unused oil infrastructure. The air compression tank can be used to pressurize unused oil wells. The compression accomplished by the pump-turbine can include one or more liquids. In further embodiments, the energy storage can use liquid air in a liquid air tank 1154. Energy can be stored using other liquids. In embodiments, energy can be stored in water storage 1160. Water storage can include pumping water to higher elevation to create a fluid head, where the fluid head can be used to spin a turbine for energy generation. The water can be fresh water, salt water, or brackish water. The WPHE can include energy distribution 1170. Energy distribution can include distributing energy locally such as around a plant or facility, a farm, a neighborhood, and so on. Energy distribution can include delivering energy from the pump-turbine to a local grid or micro-grid. Energy distribution can include providing energy farther afield. The energy distribution can include providing energy to a grid 1180. The grid can include a municipal grid, a state-wide grid, a regional grid, a national grid, etc.

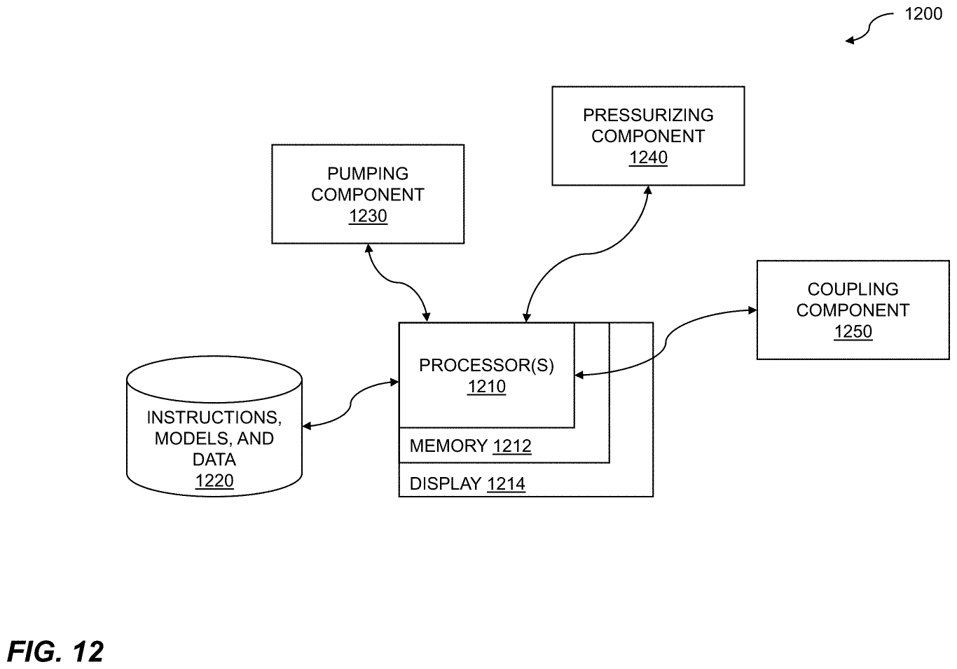

FIG. 12 is a system diagram for energy storage and buffering using multiple pressure containers. Energy manipulation is based on pumping and pressurizing a liquid and a gas for energy storage. The stored energy can be recovered and used to generate power such as electrical power by enabling operation of a turbine at an optimum level. The energy manipulation enables energy storage and buffering using multiple pressure containers. Liquid and gas are pumped into a first subterranean container. The liquid and gas are pressurized in the first subterranean container. A first pump is coupled to the first subterranean container to accomplish the pressurizing of the first subterranean container. The first pump and the first subterranean container are coupled to a first above-ground pressure vessel. The first above-ground pressure vessel is pressurized using the first pump wherein the first above-ground pressure vessel receives excess flow from the first pump beyond that flow provided to the first subterranean container.

The system 1200 can include one or more processors 1210 and a memory 1212 which stores instructions. The memory 1212 is coupled to the one or more processors 1210, wherein the one or more processors 1210 can execute instructions stored in the memory 1212. The memory 1212 can be used for storing instructions; for storing databases of energy subsystems, modules, or peers for system support; for storing hardware designs based on description languages; and the like. Information regarding energy storage and buffering can be shown on a display 1214 connected to the one or more processors 1210. The display can comprise a television monitor, a projector, a computer monitor (including a laptop screen, a tablet screen, a netbook screen, and the like), a smartphone display, a mobile device, or another electronic display. The system 1200 includes instructions, models, and data 1220. The data can include information on energy sources, energy conversion requirements, metadata about energy, and the like. In embodiments, the instructions, models, and data 1220 are stored in a networked database, where the networked database can be a local database, a remote database, a distributed database, and so on. The instructions, models, and data 1220 can include description language instructions for controlling energy storage and buffering. The instructions can further include instructions for obtaining access to one or more high-pressure vessels.

The system 1200 includes a pumping component 1230. The pumping component 1230 can pump liquid and gas into a first subterranean container. A variety of liquids can be used. In embodiments, the liquid can include water. A variety of gases can be used, where the gas that is used can have low solubility in water. In embodiments, the gas includes air. The system 1200 includes a pressurizing component 1240. The pressurizing component can pressurize the liquid and gas in the first subterranean container. The pressurizing can be accomplished using mechanical techniques including hydraulic head. The pressurizing can be accomplished using electrical techniques such as using an electric pump or an electrically operated turbine such as a pump-turbine. In embodiments, the pressurizing can be accomplished using a water piston heat engine (WPHE).

The system 1200 includes a coupling component 1250. The coupling component 1250 can couple a first pump to the first subterranean container to accomplish the pressurizing of the first subterranean container. Discussed above and throughout, the pump can include an electrically operated pump, a pump-turbine, and WPHE, and so on. In embodiments, the first pump pumps the liquid. The liquid, such as water, can be pumped into the subterranean container. In other embodiments, the first pump pumps the gas. The gas, such as air, can be pumped into the container. In embodiments, the pump can run at a substantially constant flow. The substantially constant flow can be based on an optimum operating point for the pump. The coupling component 1250 can further couple the first pump and the first subterranean container to a first above-ground pressure vessel. In embodiments, the coupling component that couples the first pump and the first subterranean container to a first above-ground pressure vessel can include a second coupling component. The pressurizing component 1240 can further pressurize the first above-ground pressure vessel using the first pump wherein the first above-ground pressure vessel receives excess flow from the first pump beyond that flow provided to the first subterranean container. In embodiments, the pressurizing component that pressurizes the first above-ground pressure vessel can include a second pressurizing component. The pressures within the subterranean container and the above-aground vessel can be substantially similar pressures or substantially different pressures. The above-ground pressure vessel can provide pressure, receive pressure, and so on. In embodiments, the first above-ground pressure vessel can provide an energy capacitance function for a system comprising the pump, the first subterranean container, and the first above-ground pressure vessel. The energy capacitance function can serve as a buffer, where the buffer can reduce pressure increases or boost pressure decreases in order to maintain a substantially constant pressure. In embodiments, the pumping, pressurizing the first subterranean container, the pressurizing the first above-ground pressure vessel, and the valves are computer controlled.

The system 1200 can include a system for energy manipulation comprising: a memory which stores instructions; one or more processors coupled to the memory wherein the one or more processors, when executing the instructions which are stored, are configured to: pump liquid and gas into a first subterranean container; pressurize the liquid and gas in the first subterranean container, wherein the pressurizing is accomplished using a first pump coupled to the first subterranean container; couple the first pump and the first subterranean container to a first above-ground pressure vessel; and pressurize the first above-ground pressure vessel using the first pump, wherein the first above-ground pressure vessel receives excess flow from the first pump beyond that flow provided to the first subterranean container. Disclosed embodiments can include a computer program product embodied in a non-transitory computer readable medium for energy manipulation, the computer program product comprising code which causes one or more processors to perform operations of: pumping liquid and gas into a first subterranean container; pressurizing the liquid and gas in the first subterranean container, wherein the pressurizing is accomplished using a first pump coupled to the first subterranean container; coupling the first pump and the first subterranean container to a first above-ground pressure vessel; and pressurizing the first above-ground pressure vessel using the first pump, wherein the first above-ground pressure vessel receives excess flow from the first pump beyond that flow provided to the first subterranean container.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for energy manipulation comprising:
pumping liquid and gas into a first subterranean container;
pressurizing the liquid and gas in the first subterranean container, wherein the pressurizing is accomplished using a first pump coupled to the first subterranean container;
coupling the first pump and the first subterranean container to a first above-ground pressure vessel; and
pressurizing the first above-ground pressure vessel using the first pump, wherein the first above-ground pressure vessel receives excess flow from the first pump beyond that flow provided to the first subterranean container.

2. The method of claim 1 wherein the first above-ground pressure vessel provides buffering for pressure flowing into or out of the first subterranean container.

3. The method of claim 1 wherein the gas includes air.

4. The method of claim 1 wherein the liquid includes water.

5. The method of claim 1 wherein the first subterranean container includes a subterranean cavern, porous rock structure, or unused well structure.

6. The method of claim 1 wherein the first subterranean container is larger than the first above-ground pressure vessel.

7. The method of claim 1 wherein the first pump pumps the liquid.

8. The method of claim 1 wherein the first pump pumps the gas.

9. The method of claim 1 wherein the first above-ground pressure vessel provides flow to the first subterranean container when pressure is higher in the first above-ground pressure vessel.

10. The method of claim 1 wherein the first above-ground pressure vessel provides an energy capacitance function for a system comprising the first pump, the first subterranean container, and the first above-ground pressure vessel.

11. The method of claim 10 wherein valves control flow into and out of the first subterranean container.

12. The method of claim 11 wherein the pumping, the pressurizing the first subterranean container, the pressurizing the first above-ground pressure vessel, and the valves are computer controlled.

13. The method of claim 1 wherein the first pump runs at substantially constant flow while providing pressure to the first subterranean container and the first above-ground pressure vessel.

14. The method of claim 1 further comprising extracting pressure from the first subterranean container to drive a first turbine.

15. The method of claim 14 wherein the extracting pressure is accomplished by taking liquid from the first subterranean container.

16. The method of claim 14 wherein the extracting pressure is accomplished by taking gas from the first subterranean container.

17. The method of claim 14 wherein pressure from the first above-ground pressure vessel supplements pressure from the first subterranean container to drive the first turbine at a substantially constant rate.

18. The method of claim 14 wherein pressure from the first subterranean container is provided to the above-ground pressure vessel to enable driving of the turbine at a substantially constant rate.

19. The method of claim 14 further comprising pressurizing a second system, comprising a second subterranean container, a second above-ground pressure vessel, and a second pump, from the first subterranean container.

20. The method of claim 19 wherein the pressurizing the second system is accomplished by injecting the gas or the liquid from the first subterranean container.

21. The method of claim 20 wherein the second subterranean container is pressurized at higher pressure than the first subterranean container, using the second pump.

22. The method of claim 21 further comprising transferring pressure from the second subterranean container to the first subterranean container to generate energy.

23. The method of claim 22 wherein the second above-ground pressure vessel provides an energy capacitance function during the transferring.

24. The method of claim 22 wherein the first above-ground pressure vessel provides an energy capacitance function during the transferring.

25. A computer program product embodied in a non-transitory computer readable medium for energy manipulation, the computer program product comprising code which causes one or more processors to perform operations of:
pumping liquid and gas into a first subterranean container;
pressurizing the liquid and gas in the first subterranean container, wherein the pressurizing is accomplished using a first pump coupled to the first subterranean container;
coupling the first pump and the first subterranean container to a first above-ground pressure vessel; and
pressurizing the first above-ground pressure vessel using the first pump, wherein the first above-ground pressure vessel receives excess flow from the first pump beyond that flow provided to the first subterranean container.

26. A system for energy manipulation comprising:
a memory which stores instructions;
one or more processors coupled to the memory wherein the one or more processors, when executing the instructions which are stored, are configured to:
pump liquid and gas into a first subterranean container;
pressurize the liquid and gas in the first subterranean container, wherein the pressurizing is accomplished using a first pump coupled to the first subterranean container;
couple the first pump and the first subterranean container to a first above-ground pressure vessel; and
pressurize the first above-ground pressure vessel using the first pump, wherein the first above-ground pressure vessel receives excess flow from the first pump beyond that flow provided to the first subterranean container.
